(19) United States
(12) Patent Application Publication
(10) Pub. No.: US 2012/0262346 A1
(43) Pub. Date: Oct. 18, 2012

(54) RADIO COMMUNICATION CARD

(76) Inventor: Shigehiro Ito, Miyagi-ken (JP)

(21) Appl. No.: 13/443,211

(22) Filed: Apr. 10, 2012

(30) Foreign Application Priority Data
Apr. 13, 2011 (JP) 2011-089118

(51) Int. Cl. H01Q 1/24

(52) U.S. Cl. 343/702

(57) ABSTRACT

A radio communication card includes a storage section that is configured to be accommodated in an internal space of a casing of an electronic apparatus and stores information supplied from the electronic apparatus, a communication section that transmits the information stored in the storage section to an external communication apparatus, and an antenna section connected to the communication section, in which the antenna section includes an antenna device patterned on a flexible substrate, is accommodated in a radio communication card casing to be withdrawable from the radio communication card casing, and is configured to transmit the information stored in the storage section to the external communication apparatus in a state in which the antenna section is withdrawn from the radio communication card casing and is withdrawn to the outside of the casing of the electronic apparatus.

### CLAIM OF PRIORITY

This application claims benefit of Japanese Patent Application No. 2011-089118 filed on Apr. 13, 2011, which is hereby incorporated by reference in its entirety.

### BACKGROUND

1. Field of the Disclosure

The present disclosure relates to a radio communication card that is mounted in an electronic apparatus and provides a memory function and a radio communication function.

2. Description of the Related Art

There is known technology in which an electronic apparatus including a digital camera is provided with a memory function and a radio communication function, and imaging information or the like is wirelessly transmitted to an external communication apparatus (for example, refer to Japanese Unexamined Patent Application Publication No. 2003-298897). In Japanese Unexamined Patent Application Publication No. 2003-298897, a radio communication card for a radio communication is inserted into a PC card slot into which a recording PC card for recording is inserted, and thereby the digital camera is provided with the radio communication function.

However, the radio communication card disclosed in Japanese Unexamined Patent Application Publication No. 2003-298897 or the like is provided with an antenna that largely projects to the outside of a casing, and thereby a card slot and a cover that have a special shape are necessary. This may be imposed restriction on their use in electronic apparatuses. When the antenna is provided inside the casing of the radio communication card, the antenna may be accommodated in the card slot, such that the restriction with respect to the electronic apparatus side disappears. However in this case, the antenna itself is accommodated in the card slot, such that there is a problem in that a radio communication distance is significantly shortened.

Particularly, in a radio communication of a radio communication standard IEEE 802.16 (so-called WiMAX) in which a communication distance of substantially several km is assumed, the significant shortening of the radio communication distance compared to a wireless LAN or the like in the related art, in which a communication distance of substantially 50 m is assumed, may result in a serious problem.

### SUMMARY

There is provided a radio communication card including a card casing accommodated in a card accommodation space in a casing of an electronic apparatus; a storage section provided within the card casing to store information supplied from the electronic apparatus; a communication section provided within the card casing to perform a radio communication with an external communication apparatus; and an antenna section connected to the communication section, wherein the antenna section includes an antenna device patterned on a flexible substrate, and is accommodated in the card casing to be withdrawable from the card casing, and the communication section transmits the information stored in the storage section to the external communication apparatus in a state in which the antenna device is withdrawn to the outside of the casing of the electronic apparatus.

According to this configuration, the antenna section is flexible, such that even when the card slot or the cover does not have a special shape, the antenna device may be withdrawn to the outside of the casing of the electronic apparatus. Therefore, it is possible to realize a radio communication card that may secure a sufficient communication distance and may not impose restrictions on usable electronic apparatuses.

### BRIEF DESCRIPTION OF THE DRAWINGS

FIGS. 1A to 10 are schematic diagrams illustrating a configuration of a radio communication card according to a first embodiment;

FIG. 2 is a schematic diagram illustrating an internal structure of a casing of the radio communication card;

FIG. 3 is a schematic diagram illustrating a structure of an antenna section of the radio communication card;

FIG. 4 is a block diagram illustrating a functional configuration of the radio communication card;

FIGS. 5A and 53 are schematic diagrams illustrating the radio communication card in a state of being accommodated in an electronic apparatus;

FIGS. 6A to 6D are schematic diagrams illustrating the radio communication card in a state in which the antenna section is withdrawn; and

FIGS. 7A and 7B are schematic diagrams illustrating a configuration of a radio communication card according to a second embodiment.

### DESCRIPTION OF THE EXEMPLARY EMBODIMENTS

Hereinafter, a radio communication card according to an embodiment of the invention will be described with reference to the attached drawings.

### First Embodiment

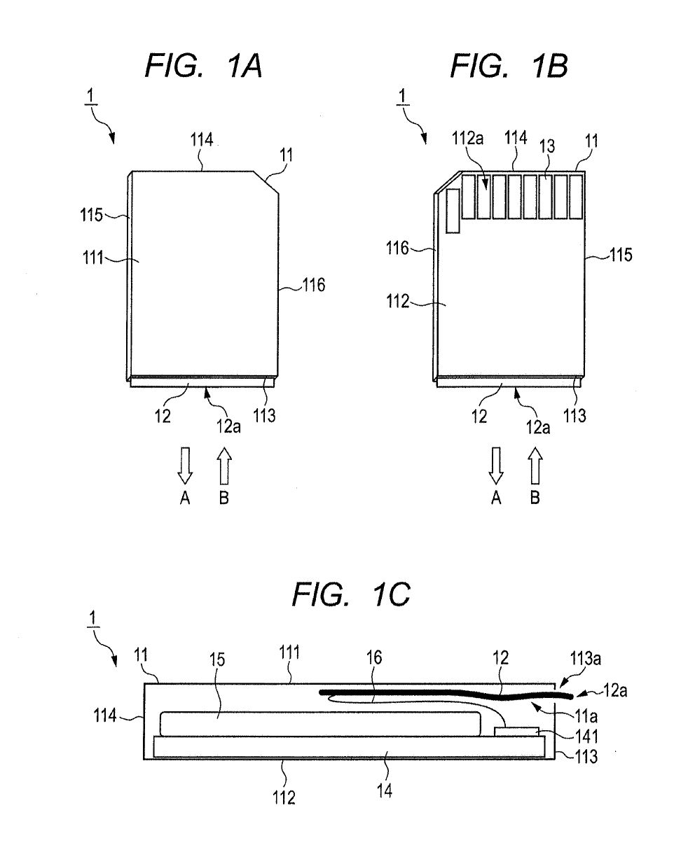

FIGS. 1A to 1C show schematic diagrams illustrating a configuration of a radio communication card 1 according to this embodiment. FIG. 1A illustrates an external appearance of the radio communication card 1 at a front surface 111 side thereof, FIG. 1B illustrates an external appearance of the radio communication card 1 at a rear surface 112 side thereof, and FIG. 1C illustrates a cross-sectional structure of the radio communication card 1.

As shown in FIGS. 1A to 1C, the radio communication card 1 according to this embodiment includes a card casing 11 that makes up an external appearance of a substantially rectangular parallelepiped shape of the radio communication card 1, a flexible antenna section 12 that is withdrawably provided at a first side wall 113 side of the card casing 11, and an external connection terminal 13 including a plurality of substantially rectangular terminals that are provided at the rear surface 112 side of the card casing 11 at positions close to a second side wall 114. For example, the radio communication card 1 is a storage device with a radio communication function such as a radio communication function built-in flash memory card or the like. The radio communication card 1 is connected to an electronic apparatus at the external connection terminal 13, and allows the electronic apparatus to have a memory function and a radio communication function of a radio communication standard IEEE 802.16.

A substantially rectangular opening 113a for an antenna section is formed in the first side wall 113 of the card casing 11 to allow the flexible antenna section 12 to be accommodated in an internal space 11a and to be withdrawn from the internal space 11a (FIG. 10). An opening 112a for an external connection terminal, which includes a plurality of substantially rectangular openings, is formed in the rear surface 112 at a position close to the second side wall 114 so as to expose the external connection terminal 13 (FIG. 1B).

The antenna section 12 is disposed inside the card casing 11 in a manner such that one end 12a thereof is exposed to the outside of the card casing 11. The antenna section 12 may be withdrawn along a third side wall 115 and a fourth side wall 116 that are substantially orthogonal to the first side wall 113 and the second side wall 114 when the one end 12a is pulled with a force A in a direction (a downward direction in FIGS. 1A and 1B) facing the first side wall 113 from the second side wall 114. In addition, the withdrawn antenna section 12 may be again accommodated in the card casing 11 when a force B is applied in a direction (an upward direction in FIGS. 1A and 1B) facing the second side wall 114 from the first side wall 113.

As shown in FIG. 10, a substrate 14 represented by a printed circuit board is disposed on an inner wall of the card casing 11 at the rear surface 112 side thereof. A mounted component 15 such as an IC chip having a radio communication function and an information storage function is mounted on the substrate 14 at the front surface 111 side thereof. A power supply section 141, which supplies power to the antenna section 12, is mounted on the substrate 14 at the front surface 111 side position thereof close to the first side wall 113. The power supply section 141 is connected to the antenna section 12 through a conductive line 16 such as a coaxial cable. A plurality of substantially rectangular terminals, which make up the external connection terminal 13, are provided on the substrate 14 at the rear surface 112 side at a position corresponding to the opening 112a for an external connection terminal of the card casing 11.

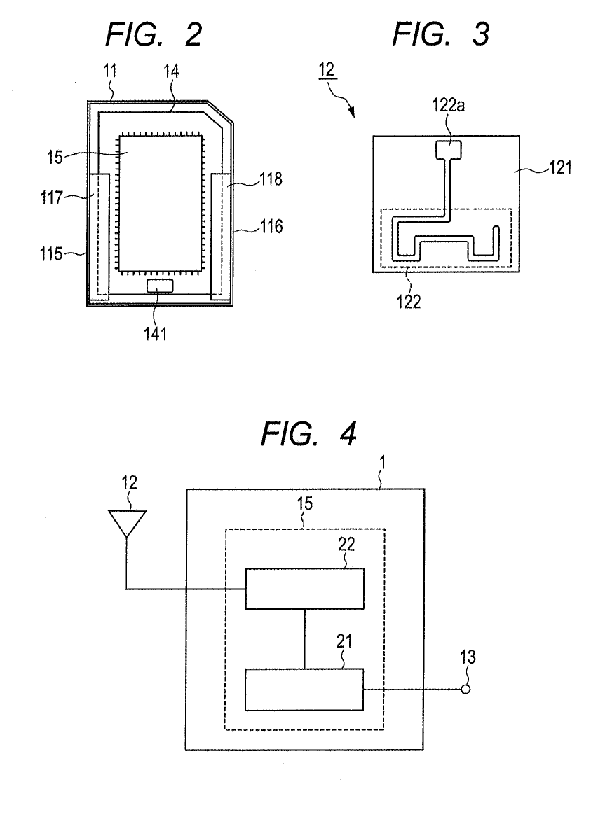

FIG. 2 shows a schematic diagram illustrating an internal structure of the card casing 11 of the radio communication card 1 according to this embodiment, which is seen from the front surface 111 side. In FIG. 2, a partial configuration such as the antenna section 12 is omitted. The substrate 14 having a substantially rectangular shape, which is provided with the power supply section 141, is disposed in the card casing 11, and the mounted component 15 such as an IC chip is mounted on the substrate 14. In addition, guide sections 117 and 118, which regulate an accommodation position of the antenna section 12 and guide a withdrawing operation and an accommodating operation of the antenna section 12, are provided on the third side wall 115 and the fourth side wall 116 in the inside of the card casing 11. The guide sections 117 and 118 are members that have a surface that is substantially parallel with respect to the front surface 111 and the rear surface 112. Deformation of the antenna section 12, which is unnecessary, at the time of the withdrawing operation or the accommodating operation may be suppressed due to the guide sections 117 and 118, such that the withdrawing operation or the accommodating operation of the antenna section 12 may be smoothly performed.

FIG. 3 shows a schematic diagram illustrating a configuration of the antenna section 12 of the radio communication card 1 according to this embodiment. As shown in FIG. 3, the antenna section 12 includes a substantially rectangular film 121 (a flexible substrate) formed from an insulating flexible material, and an antenna device 122 that is formed on a surface of the film 121 by a printing process or the like and is formed of a conductive material. A connection section 122a to be connected with the conductive line 16 is formed at one end side of the antenna device 122. The film antenna, which uses the film 121 formed of a flexible material as a base material, may be easily deformed, such that the radio communication card 1 is disposed in a slot serving as a card accommodating space of an electronic apparatus, and then the antenna section 12 may be withdrawn through a gap formed in a casing of an electronic apparatus. Therefore, even when a card slot and a cover that have a special shape are not provided to the electronic apparatus side, the antenna section 12 may be withdrawn to the outside of the casing of the electronic apparatus and a sufficient communication distance may be secured. In addition, a surface of the antenna device 122 may be coated with a resin material or the like.

FIG. 4 shows a block diagram illustrating a functional configuration of the radio communication card 1 according to this embodiment. As shown in FIG. 4, the radio communication card 1 includes a storage section 21 that stores information transmitted from the electronic apparatus through the external connection terminal 13, and a communication section 22 that controls radio communication with an external communication apparatus. The communication section 22 generates a transmission signal in which the information stored in the storage section 21 is used as transmission data in response to an instruction from the electronic apparatus, and supplies the generated signal to the antenna section 12. When the transmission signal is supplied to the antenna section 12, the antenna section 12 converts the transmission signal to a radio wave and wirelessly transmits the radio wave. In this manner, the information stored in the storage section 21 is transmitted to the external communication apparatus. The functions of the storage section 21 and the communication section 22 are realized by the mounted component 15 such as an IC chip.

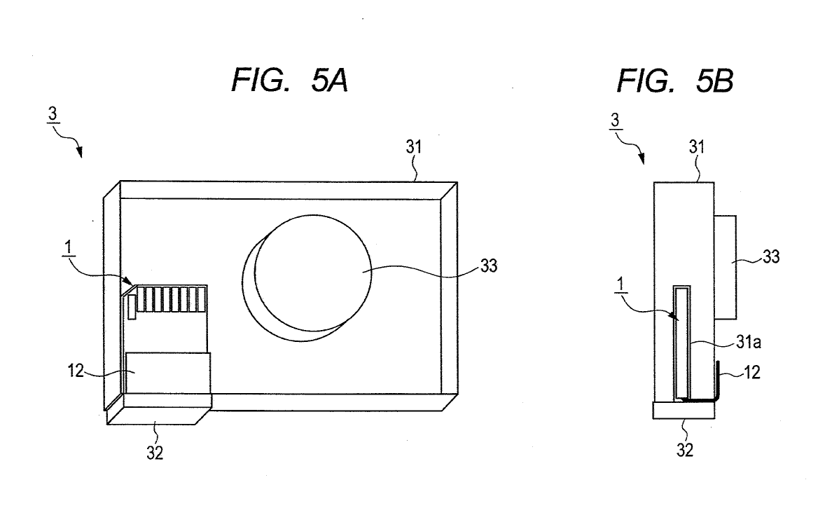

In the case of performing the radio communication using the radio communication card 1 configured as described above, the antenna section 12 is withdrawn from the card casing 11 to be used. FIGS. 5A and 5B show schematic diagrams illustrating an aspect of the radio communication card 1 in a state of being accommodated in a digital camera 3 that is an electronic apparatus. FIG. 5A illustrates an external appearance of the digital camera 3 in which the radio communication card 1 is accommodated in the card slot, and FIG. 5B illustrates a side surface of the digital camera 3. The digital camera 3 shown in FIGS. 5A and 5B includes a casing 31 having a card slot (internal space) 31a that is configured to accommodate the radio communication card 1, a cover 32 that covers the card slot 31a, and a lens 33 that is provided at a front surface of the casing 31.

The radio communication card 1 is inserted in the card slot 31a from the external connection terminal 13 side (the second side wall 114 side) in a state in which the antenna section 12 is withdrawn from the card casing 11. The antenna section 12 is withdrawn to the outside of the digital camera 3 through a gap between the casing 31 and the cover 32 of the digital camera 3. In addition, the antenna section 12 is fixed to the outside of the casing 31 of the digital camera 3 by an arbitrary fixing unit. The antenna section 12 of the radio communication card 1 is configured to be flexible, such that the antenna section 12 may be withdrawn to the outside through a minute gap between the casing and the cover of the electronic apparatus.

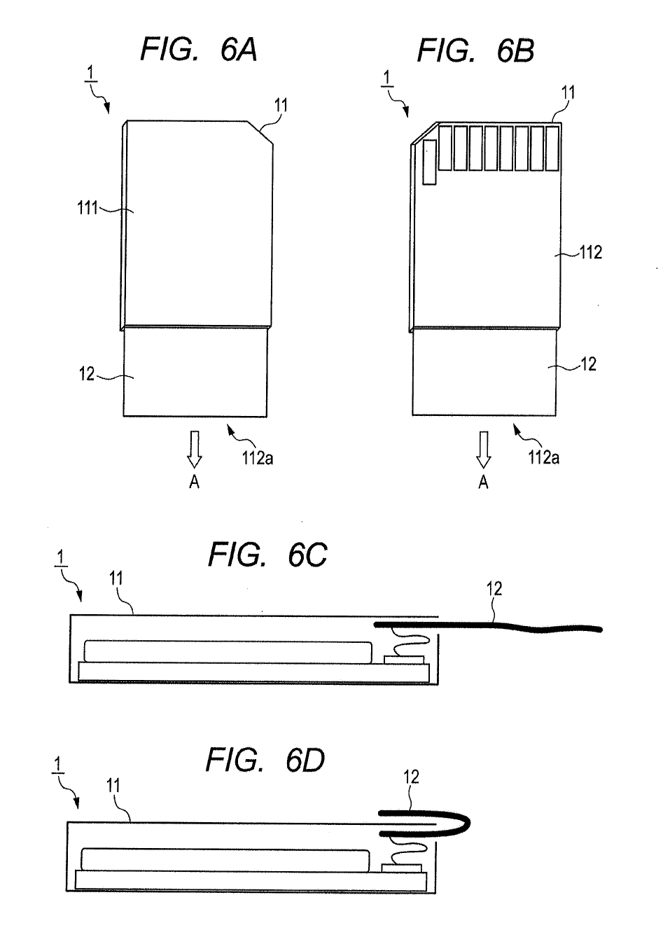

FIGS. 6A and 6D show schematic diagrams illustrating the radio communication card 1 in a state in which the antenna section 12 is withdrawn. FIG. 6A illustrates a front surface 111 side external appearance of the radio communication card 1 from which the antenna section 12 is withdrawn, FIG. 6B illustrates a rear surface 112 side external appearance of the radio communication card 1 from which the antenna section 12 is withdrawn, and FIGS. 6C and 6D illustrate a cross-section of the radio communication card 1 from which the antenna section 12 is withdrawn.

The radio communication card 1 is configured in a manner such that when the force A in a drawing direction in FIG. 6A is applied with respect to the one end 12a of the antenna section 12, the antenna section 12 may be withdrawn. When the force A in the withdrawing direction is applied to the one end 12a of the antenna section 12 and the antenna section 12 is withdrawn from the card casing 11, an area of the antenna section 12, which is exposed from the card casing 11, increases (for example, refer to FIGS. 1A and 5A). In this manner, the antenna device 122 of the antenna section 12 is exposed to the outside of the card casing 11.

The antenna section 12 that is withdrawn for a radio communication may be deformed in correspondence with a shape or the like of the electronic apparatus. For example, in an aspect shown in FIG. 6D, the antenna section 12 may be bent to the front surface 111 side. The antenna section 12 is a flexible antenna represented by a film antenna, such that even when being deformed in this manner, the antenna section 12 may exhibit a sufficient communication characteristic.

As described above, in the radio communication card 1 according to this embodiment, the antenna section 12 is flexible, such that the antenna section 12 may be withdrawn to the outside through a gap between the casing and cover of the electronic apparatus. Therefore, even when a card slot and a cover that have a special shape are not provided to the electronic apparatus side, the antenna section 12 may be withdrawn to the outside of the casing of the electronic apparatus and a sufficient communication distance may be secured.

This embodiment may be implemented by being appropriately combined with a configuration described in another embodiment.

### Second Embodiment

In this embodiment, a radio communication card having a configuration different from that of the above-described embodiment will be described. A radio communication card 1a according to this embodiment corresponds to the radio communication card 1 according to the above-described embodiment except that a configuration of the card casing 11 is changed. Hereinafter, description will be made with respect to a difference and redundant description will not be repeated. In addition, the same reference numerals will be given to the same components as those of the above-described embodiment.

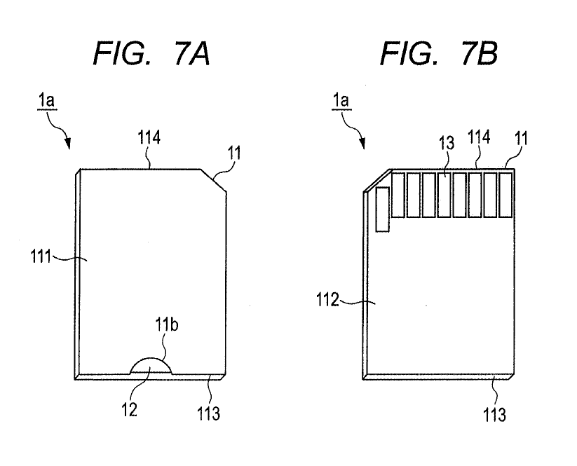

FIGS. 7A and 7B show schematic diagrams illustrating a configuration of a radio communication card 1a according to this embodiment. FIG. 7A illustrates a front surface 111 side external appearance of the radio communication card 1a, and FIG. 7B illustrates a rear surface 112 side external appearance of the radio communication card 1a. The radio communication card 1a includes a card casing 11 that makes up an external appearance of a substantially rectangular parallelepiped shape of the radio communication card 1a, a flexible antenna section 12 that is withdrawably provided at a first side wall 113 side of the card casing 11, and an external connection terminal 13 including a plurality of substantially rectangular terminals that are provided at the rear surface 112 side of the card casing 11 at positions close to a second side wall 114.

The card casing 11 of the radio communication card 1a according to this embodiment has a semicircular cut-out section 11b at the first side wall 113 side of the front surface 111. In addition, in the cut-out section 11b, a part of the antenna section 12 is exposed at the cut-out section 11b. Therefore, it is possible to withdraw the antenna section 12 with the antenna section 12 exposed at the cut-out section 11b being grasped. In this configuration, the antenna section 12 may be easily withdrawn from the card casing 11. In addition, even when the antenna section 12 is completely accommodated in the internal space of the card casing 11, the antenna section 12 may be withdrawn, such that the volume of the antenna section 12 does not become bulky.

This embodiment may be implemented by being appropriately combined with a configuration described in another embodiment.

As described above, according to this embodiment of the invention, the antenna section is flexible, such that even when the card slot or the cover do not have a special shape, the antenna section may be withdrawn to the outside of the casing of the electronic apparatus. Therefore, it is possible to realize a radio communication card that may secure a sufficient communication distance and may not impose restrictions on usable electronic apparatuses.

In addition, the present invention is not limited to the description in the above-described embodiments, and may be implemented in a state of being appropriately changed to an aspect exhibiting the effect of the invention. In addition, the size and shape of the configurations shown in the accompanying drawings may be appropriately changed within a scope exhibiting the effect of the invention. For example, the size of the antenna section or the pattern of the antenna device may be changed in correspondence with a usable frequency band, transmission power, or the like.

In addition to this, the invention may be appropriately modified and implemented without departing from the scope of the invention.

The invention is useful, for example, as a radio communication function built-in storage device used in an electronic apparatus such as a digital camera.

It should be understood by those skilled in the art that various modifications, combinations, sub-combinations and alterations may occur depending on design requirements and other factors insofar as they are within the scope of the appended claims of the equivalents thereof.

What is claimed is:

1. A radio communication card comprising:
a card casing accommodated in a card accommodation space in a casing of an electronic apparatus;
a storage section provided within the card casing to store information supplied from the electronic apparatus;
a communication section provided within the card casing to perform a radio communication with an external communication apparatus; and
an antenna section connected to the communication section,
wherein the antenna section includes an antenna device patterned on a flexible substrate, and is accommodated in the card casing to be withdrawable from the card casing, and
the communication section transmits the information stored in the storage section to the external communication apparatus in a state in which the antenna device is withdrawn to the outside of the casing of the electronic apparatus.

2. The radio communication card according to claim 1,
wherein the casing of the electronic apparatus is provided with a cover opening and closing an opening section of the card accommodation space, and
the antenna device drawn from the card casing accommodated in the card accommodation space is drawn to the outside from a gap between the cover covering the opening section of the card accommodation space and the casing of the electronic apparatus.

3. The radio communication card according to claim 1,
wherein the card casing includes a guide section guiding taking in and out of the antenna section and determining an accommodation position.

4. The radio communication card according to claim 1,
wherein the card casing has a cut-out section from which a part of the antenna section is exposed.

5. The radio communication card according to claim 1,
wherein the radio communication card is a radio communication function built-in flash memory card.

6. The radio communication card according to claim 1,
wherein the radio communication card is configured to perform radio communication of a radio communication standard IEEE 802.16.

7. The radio communication card according to claim 1,
wherein the electronic apparatus is a digital camera.
